(19) United States
(12) Patent Application Publication
(10) Pub. No.: US 2013/0195441 A1
(43) Pub. Date: Aug. 1, 2013

(54) BIDIRECTIONAL OPTICAL TRANSMITTING AND RECEIVING DEVICE

(71) Applicants: Jong Jin LEE, Gwangju (KR); Jong Deog Kim, Gwangju (KR)

(72) Inventors: Jong Jin LEE, Gwangju (KR); Jong Deog Kim, Gwangju (KR)

(73) Assignee: ELECTRONICS AND TELECOMMUNICATIONS RESEARCH INSTITUTE, Daejeon (KR)

(21) Appl. No.: 13/565,053

(22) Filed: Aug. 2, 2012

(30) Foreign Application Priority Data
Sep. 21, 2011 (KR) 10-2011-0095219

(51) Int. Cl. H04B 10/40

(52) U.S. Cl. CPC H04B 10/40
USPC 398/9; 398/135

(57) ABSTRACT

Disclosed is a bidirectional optical transmitting and receiving device which includes a bottom case; a sidewall case; an upper case; a thermoelectric cooler provided on a first portion of the bottom case; a temperature sensor, a light emitting element, and a first lens collecting light emitted from the light emitting element, the temperature sensor, the light emitting element, and the first lens formed over the thermoelectric cooler; a second lens contacting with the exterior via the sidewall case; a filter transmitting light propagated from the first lens to the second lens and reflecting light propagated from the second lens; a third lens coupled with a lower surface of the filter and collecting light reflected from the filter; a light receiving element provided on a second portion of the bottom case and receiving light propagated from the third lens to output an electric signal; a pre-amplifier provided on the second portion and amplifying the electric signal from the light emitting element; and a support formed on the second portion and supporting the filter.

### CROSS-REFERENCE TO RELATED APPLICATIONS

A claim for priority under 35 U.S.C. §119 is made to Korean Patent Application No. 10-2011-0095219 filed Sep. 21, 2011, in the Korean Intellectual Property Office, the entire contents of which are hereby incorporated by reference.

### BACKGROUND

Exemplary embodiments relate to an optical device, and more particularly, relate to a bidirectional optical transmitting and receiving device.

Optical communication may be a high-capacity communication technology. With the optical communication, a transmission signal may be converted into an optical signal at a transmitter side, and the converted optical signal may be transmitted via a medium such as an optical fiber. The optical signal may be converted into an original signal at a receiver side.

A bidirectional optical transmitting and receiving device transmitting and receiving optical signals via one optical fiber may be used to reduce the surcharge such as an installed charge and a rental fee of the optical fiber. The bidirectional optical transmitting and receiving device may include an optical transmitter and an optical receiver. An optical transmission function of the bidirectional optical transmitting and receiving device may be affected by a temperature. A noise of an optical signal generated at the bidirectional optical transmitting and receiving device may increase when a temperature varies. Also, the bidirectional optical transmitting and receiving device may be configured such that no interference between a transmitted optical signal and a received optical signal is generated. In general, the bidirectional optical transmitting and receiving device may include the optical transmitter and the optical receiver that are fabricated in an airtight structure.

### SUMMARY

Example embodiments of the inventive concept provide a bidirectional optical transmitting and receiving device comprising a bottom case; a sidewall case; an upper case; a thermoelectric cooler provided on a first portion of the bottom case; a temperature sensor, a light emitting element, and a first lens collecting light emitted from the light emitting element, the temperature sensor, the light emitting element, and the first lens formed over the thermoelectric cooler; a second lens contacting with the exterior via the sidewall case; a filter transmitting light propagated from the first lens to the second lens and reflecting light propagated from the second lens; a third lens coupled with a lower surface of the filter and collecting light reflected from the filter; a light receiving element provided on a second portion of the bottom case and receiving light propagated from the third lens to output an electric signal; a pre-amplifier provided on the second portion and amplifying the electric signal from the light emitting element; and a support formed on the second portion and supporting the filter.

In example embodiments, the bidirectional optical transmitting and receiving device further comprises at least one lead pin for reception penetrating the bottom case and receiving the electric signal amplified by the pre-amplifier.

In example embodiments, the bidirectional optical transmitting and receiving device further comprises at least one lead pin for transmission penetrating the sidewall case and transferring an electric signal to the light emitting element.

In example embodiments, the second lens collects light transmitted by the filter to transfer the collected light to the exterior.

In example embodiments, the second lens transmits light passing through the filter to the exterior.

In example embodiments, the bidirectional optical transmitting and receiving device further comprises a monitor element provided on the thermoelectric cooler and monitoring light emitted from the light emitting element.

In example embodiments, the bidirectional optical transmitting and receiving device further comprises an isolator provided on the thermoelectric cooler and between the filter and the first lens.

In example embodiments, light reflected by the filter is directly propagated to the light receiving element via the third lens.

In example embodiments, the support surrounds the light receiving element and the pre-amplifier with the bottom case and the filter.

In example embodiments, the support has a light blocking function.

In example embodiments, the support comprises a sidewall extending in a direction perpendicular to an upper surface of the bottom case; and an upper surface coupled with an upper surface of the sidewall and provided over the second portion in parallel with the upper surface of the bottom case, wherein a hole is provided at the upper surface of the support to expose the light emitting element.

In example embodiments, the filter is provided on the hole.

In example embodiments, the bidirectional optical transmitting and receiving device further comprises a substrate provided on the thermoelectric cooler, the temperature sensor and the light emitting element provided on the substrate.

In example embodiments, the bottom case, the sidewall case, the upper case, and the second lens are sealed by a laser welding process.

Another aspect of embodiments of the inventive concept is directed to provide

Still another aspect of embodiments of the inventive concept is directed to provide

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a perspective view of a bidirectional optical transmitting and receiving device according to an embodiment of the inventive concept.

FIG. 2 is an explored perspective view of a bidirectional optical transmitting and receiving module.

FIG. 3 is a cross-sectional view of a bidirectional optical transmitting and receiving.

FIG. 4 is a block diagram illustrating an optical transmitting and receiving operation of a bidirectional optical transmitting and receiving device according to an embodiment of the inventive concept.

FIG. 5 is a block diagram schematically illustrating a bidirectional optical transmitting and receiving device according to application of the inventive concept.

FIG. 6 is a flowchart illustrating a fabrication method of a bidirectional optical transmitting and receiving device according to an embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

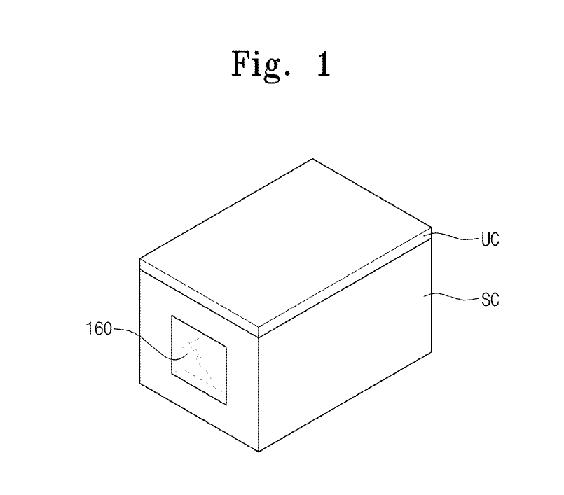

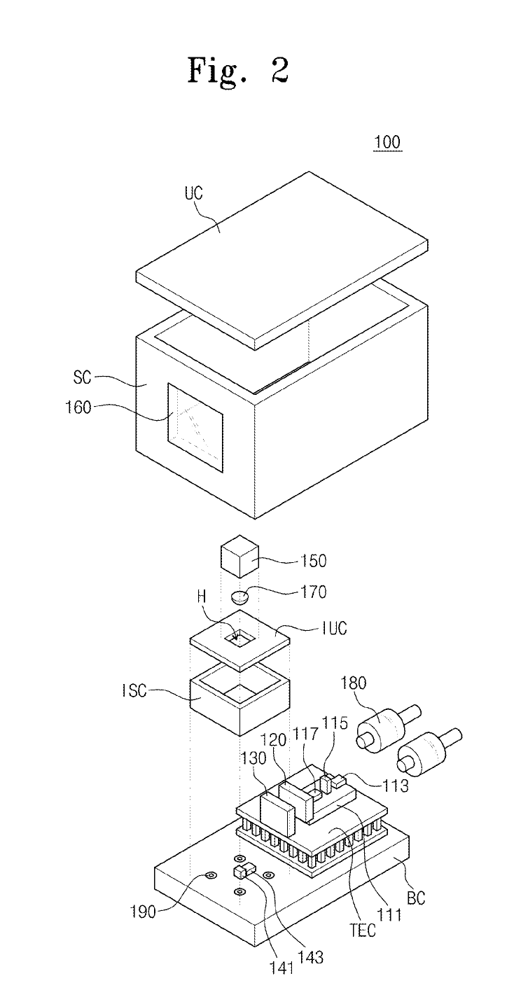

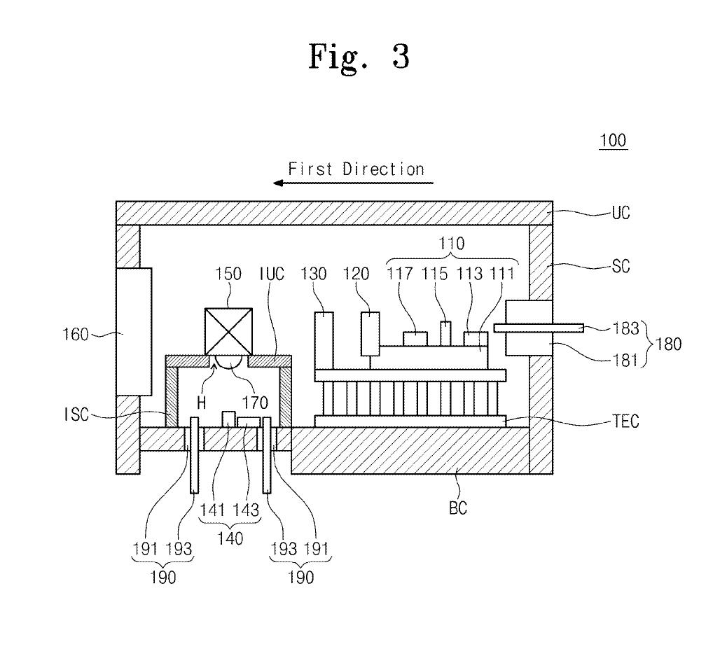

FIG. 1 is a perspective view of a bidirectional optical transmitting and receiving device according to an embodiment of the inventive concept. FIG. 2 is an explored perspective view of a bidirectional optical transmitting and receiving module. FIG. 3 is a cross-sectional view of a bidirectional optical transmitting and receiving.

Referring to FIGS. 1 to 3, a bottom case BC may be provided. A thermoelectric cooler TEC may be provided at a first portion of the bottom case BC. A transmitting unit 110 may be provided on the thermoelectric cooler TEC. The transmitting unit 110 may include a substrate 111, a temperature sensor 113, a monitor element 115, and a light emitting element 117. The components 113, 115, and 117 may be provided on the substrate 111, a

The substrate 111 may include an insulation material. The substrate 111 can include a light blocking material.

The temperature sensor 113 may measure a temperature of the transmitting unit 110 to send it to the thermoelectric cooler TEC. Cooling of the thermoelectric cooler TEC may be made according to a result measured by the temperature sensor 113.

The monitor element 115 may monitor light emitted by the light emitting element 117. The monitor element 115 may be a light receiving element configured to convert light emitted by the light emitting element 117 into an electric signal.

The light emitting element 117 may emit light based on an input electric signal.

A first lens 120 may be provided on the substrate 111 or on the thermoelectric cooler TEC. The first lens 120 may be provided in a first direction from the light emitting element 111.

An isolator 130 may be provided on the thermoelectric cooler TEC. The isolator 130 may be located on the same line as the light emitting element 117 and the first lens 120. The isolator 130 may be provided in a first direction from the first lens 120.

A receiving unit 140 may be provided on a second portion of the bottom case BC. The receiving unit 140 may include a light receiving element 141 and a pre-amplifier 143. The light receiving element 141 may convert input light into an electric signal. The pre-amplifier 143 may amplify an electric signal converted by the light receiving element 143.

A support ISC extending in parallel with an upper surface of the bottom case BC on the second portion of the bottom case BC may be provided on the second portion of the bottom case BC to be spaced apart from the upper surface of the bottom case BC and to extend in a direction perpendicular to the upper surface of the bottom case BC. A hole H may be formed at an upper surface of the support ISC to expose an upper surface of the light receiving element 121. The support ISC may include an insulation material. Alternatively, the support ISC may include a light blocking material.

A filter 150 may be provided on the hole H of the support ISC. The filter 150 may be located on the same line as the light emitting element 117, the first lens 120, and an isolator 130. The filter 150 may be located at a first direction from the first lens 120. The filter 150 may transmit light having a first frequency band and reflect light having a second frequency band.

A sidewall case SC may be coupled around the bottom case BC. The sidewall case SC may surround the bottom case SC and extend in a direction perpendicular to the bottom case BC.

A second lens 160 may be provided to penetrate the sidewall case SC.

The second lens 160 may be located on the same line as the light emitting element 117, the first lens 120, an isolator 130, and the filter 150. The second lens 160 may contact with the interior and exterior of the bidirectional optical transmitting and receiving device 100 via the sidewall case SC.

A third lens 170 may be provided on a lower surface of the filter 150. In example embodiments, the third lens 170 may be coupled with the lower surface of the filter 150. The third lens 170 may be located on the same line as the light receiving element 121 and the filter 150.

A plurality of lead pins 180 each including a conductor 181 and a dielectric 183 may be provided to penetrate the sidewall case SC. The plurality of lead pins 180 may be provided at portions of the sidewall case SC adjacent to the thermoelectric cooler TEC. The plurality of lead pins 180 may be a plurality of lead pins for transmission. Signals transmitted via the plurality of lead pins 180 may be transferred to the light emitting element 117. The plurality of lead pins 180 may act as a plurality of coaxial cables with the sidewall case SC. The sidewall case SC may be used as a common ground of the plurality of coaxial cables. If the plurality of lead pins 180 is used as a plurality of coaxial cables, it is possible to communicate in high speed using the plurality of lead pins 180. The number and location of the plurality of lead pins 180 may not be limited to this disclosure.

A plurality of lead pins 190 may be provided at the second portion of the bottom case BC to penetrate the bottom case BC. Each lead pin 190 may include a conductor 191 and a dielectric 193 surrounding the conductor 191. The plurality of lead pins 190 may be a plurality of lead pins for reception. Electric signals that are generated from the light receiving element 141 and are amplified by the pre-amplifier 143 may be output to the exterior via the plurality of lead pins 190. The plurality of lead pins 190 may act as a plurality of coaxial cables with the bottom case BC. For example, the bottom case BC may be used as a common ground of the plurality of coaxial cables. If the plurality of lead pins 190 is used as a plurality of coaxial cables, it is possible to communicate in high speed using the plurality of lead pins 180. The number and location of the plurality of lead pins 190 may not be limited to this disclosure.

An upper case UC may be coupled at an upper surface of the sidewall case SC. The interior and exterior of the bidirectional optical transmitting and receiving device 100 may be blocked by the bottom case BC, the sidewall case SC, the upper case UC, the second lens 160, and the plurality of lead pins 180 and 190. That is, the bidirectional optical transmitting and receiving device 100 may be sealed in an airtight structure.

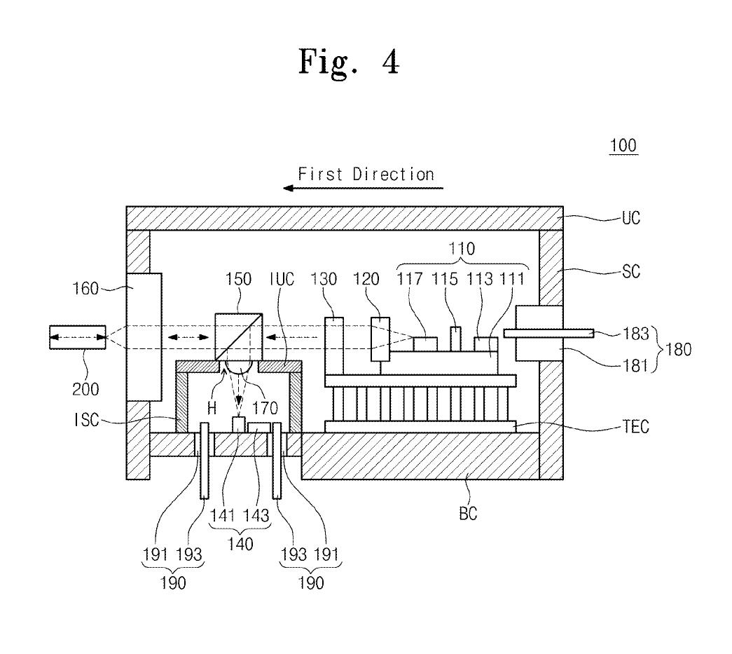

FIG. 4 is a block diagram illustrating an optical transmitting and receiving operation of a bidirectional optical transmitting and receiving device according to an embodiment of the inventive concept. Referring to FIG. 4, a first electric signal may be received via lead pins 180. The first electric signal may be a transmission signal to be sent via a bidirectional optical transmitting and receiving device 100. A light emitting element 117 may emit light in response to the first electric signal input via the lead pins 180. The light emitting element 117 may emit light in a first direction.

The first lens 120 may convert light emitted from the light emitting element 117 into a first parallel ray. The first lens 120 may refract light emitted from the light emitting element 117 to be converted into a first parallel ray. The first parallel ray may be inducted to an isolator 130 along a first direction.

The isolator 130 may transmit light propagated from the first lens 120 along the first direction. The light transmitted by the isolator 130 may be sent to a filter 150. The isolator 130 may block light propagated from the filter 150.

The filter 150 may have selective transmission and reflection characteristics. The filter 150 may transmit light having a first frequency band and reflect light having a second frequency band. A pass band of the filter 150 may correspond to a frequency of light emitted from the light emitting element 117. That is, the filter 150 may transmit light transferred from the light emitting element 117 via the first lens 120 and he isolator 130. Light passing through the filter 150 may be induced to a second lens along the first direction.

The second lens 160 may collect light incident from the filter 150 to be induced to an optical filter 200. That is, the first electric signal supplied to the bidirectional optical transmitting and receiving device 100 via the lead pins 180 may be converted into light via the light emitting element 117, and may be controlled via the first lens 120, the isolator 130, the filter 150, and the second lens 160 to be output to the optical fiber 200.

Light transmitted to the bidirectional optical transmitting and receiving device 100 via the optical fiber 200 may be incident to the second lens 160. The second lens 160 may convert light incident from the optical fiber 200 into a second parallel ray. The second lens 160 may refract light incident from the optical fiber 200 to be converted into the second parallel ray. The second parallel ray may be induced to the filter 150 along a direction opposite to the first direction.

A refraction band of the filter 150 may correspond to a frequency of light emitted from the optical fiber 200. That is, the filter 150 may refract light incident from the optical fiber 200 via the second lens 160. The filter 150 may refract incident light to a third lens 170.

The third lens 170 may collect light refracted from the filter 150 to be induced to a light receiving element 141. The light receiving element 141 may convert light incident from the third lens 170 into the second electric signal. A pre-amplifier 143 may amplify the second electric signal to output it to lead pins 190. That is, light propagated to the bidirectional optical transmitting and receiving device 100 from the optical fiber 200 may be controlled by the second lens 160, the filter 150, and the third lens 170, converted into the second electric signal by the light receiving element 141, and amplified by the pre-amplifier 143.

Components of the transmitting unit 110 may be formed on a thermoelectric cooler TEC. Thus, the stability and reliability of light generated by the transmitting unit 110 may be improved. The transmitting and receiving units 110 and 140 of the bidirectional optical transmitting and receiving device 100 may be formed within one case. Since the transmitting and receiving units 110 and 130 need not be sealed each other in an airtight structure, they may be provided within a sealed case. Thus, compared with the case that the transmitting and receiving units 110 and 140 are sealed in an airtight structure, a process may be simply, a time taken to make it may be shortened, and a cost may be lowered.

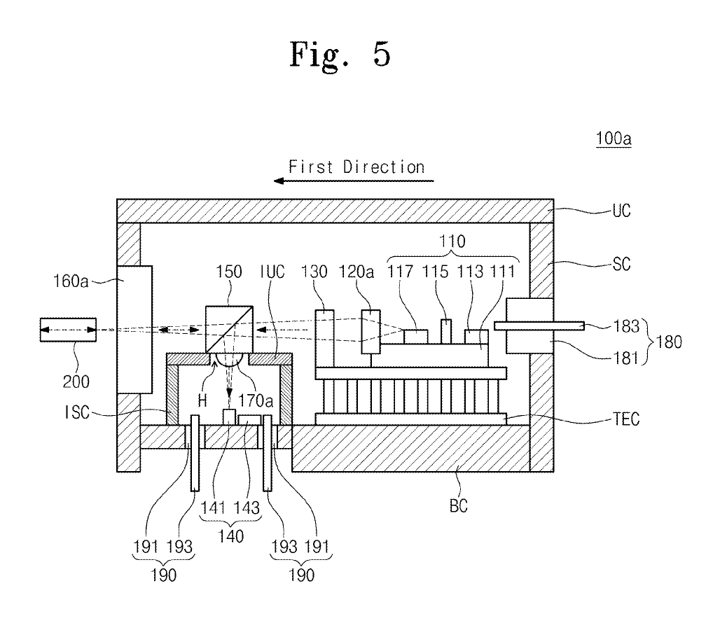

FIG. 5 is a block diagram schematically illustrating a bidirectional optical transmitting and receiving device according to application of the inventive concept. Compared with a bidirectional optical transmitting and receiving device 100 described with reference to FIGS. 1 to 4, a second lens 160a of a bidirectional optical transmitting and receiving device 100a in FIG. 5 may transmit incident light.

A first lens 120a may collect light emitted from a light emitting element 117 to transfer it in a first direction. Light collected by the first lens 120a may penetrate an isolator 130 and a filter 150 to be transferred to the second lens 160a. Incident light may penetrate the second lens 160a as it is. Light passing through the second lens 160a may be incident to an optical fiber 200. The second lens 160a may collect light emitted from a light emitting element 117 such that collected light is focused on an incident surface of the optical fiber 200.

Light emitted from the optical fiber 200 may pass through the second lens 160a as it is. Light transmitting the second lens 160a may be refracted by the filter 150 to be sent to a third lens 170a. The third lens 170a may collect incident light to transfer it to a light receiving element 141. For example, the third lens 170a may collect incident light such that collected light is focused on an incident surface of the light receiving element 141.

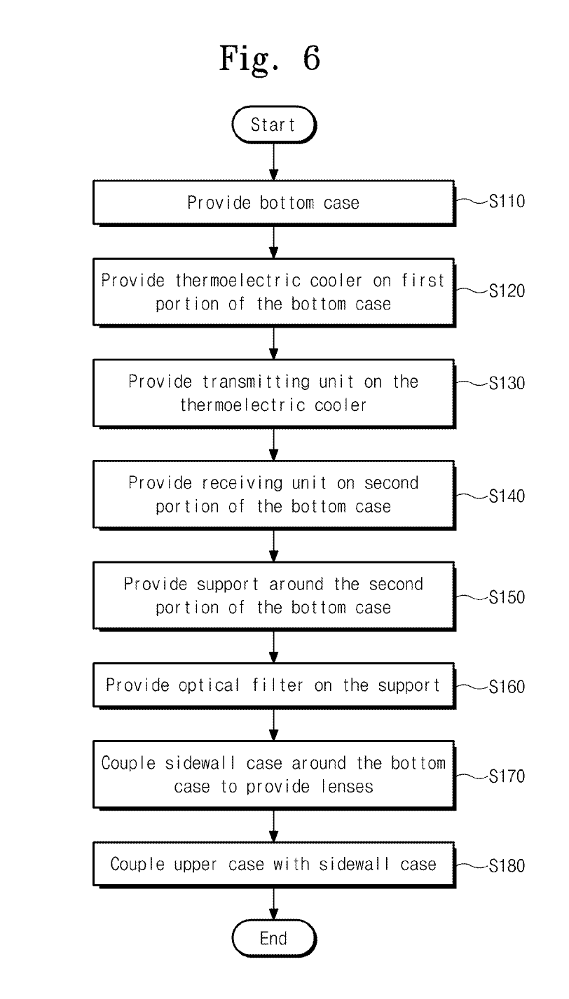

FIG. 6 is a flowchart illustrating a fabrication method of a bidirectional optical transmitting and receiving device according to an embodiment of the inventive concept. Referring to FIGS. 1 to 6, in operation S110, a bottom case BC may be provided.

In operation S120, a thermoelectric cooler TEC may be provided on a first portion of the bottom case BC.

In operation S130, a transmitting unit 110 may be provided on the thermoelectric cooler TEC. The transmitting unit 110 may include a temperature sensor 113, a monitor element 115, and a light emitting element 117.

In operation S140, a receiving unit 140 may be provided on a second portion of the bottom case BC. The receiving unit 140 may include a light receiving element 141 and a pre-amplifier 143.

In operation S150, a support ISC may be provided around the second portion of the bottom case BC. The support ISC may extend in a direction perpendicular to an upper surface of the bottom case BC, and may be spaced apart from the bottom case BC to extend in parallel with the bottom case BC. A hole H may be provided on an upper surface of the support ISC to expose the light receiving element 141.

In operation S160, an optical filter 150 may be provided on the support ISC. The optical filter 150 may be coupled with a third lens 170. The optical filter 150 may be provided on the hole H of the support ISC.

In operation S170, a sidewall case SC may be coupled around the bottom case BC, and lenses 120 and 160 may be provided. The first lens 120 may be provided over the thermoelectric cooler TEC or on a substrate 111. The second lens 160 may be provided to penetrate the sidewall case SC.

In operation S180, an upper case UC may be coupled with the sidewall case SC. A bidirectional optical transmitting and receiving device 100 may be sealed by the laser welding.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A bidirectional optical transmitting and receiving device comprising:
a bottom case;
a sidewall case;
an upper case;
a thermoelectric cooler provided on a first portion of the bottom case;
a temperature sensor, a light emitting element, and a first lens collecting light emitted from the light emitting element, the temperature sensor, the light emitting element, and the first lens formed over the thermoelectric cooler;
a second lens contacting with the exterior via the sidewall case;
a filter transmitting light propagated from the first lens to the second lens and reflecting light propagated from the second lens;
a third lens coupled with a lower surface of the filter and collecting light reflected from the filter;
a light receiving element provided on a second portion of the bottom case and receiving light propagated from the third lens to output an electric signal;
a pre-amplifier provided on the second portion and amplifying the electric signal from the light emitting element; and
a support formed on the second portion and supporting the filter.

2. The bidirectional optical transmitting and receiving device of claim 1, further comprising:
at least one lead pin for reception penetrating the bottom case and receiving the electric signal amplified by the pre-amplifier.

3. The bidirectional optical transmitting and receiving device of claim 1, further comprising:
at least one lead pin for transmission penetrating the sidewall case and transferring an electric signal to the light emitting element.

4. The bidirectional optical transmitting and receiving device of claim 1, wherein the second lens collects light transmitted by the filter to transfer the collected light to the exterior.

5. The bidirectional optical transmitting and receiving device of claim 1, wherein the second lens transmits light passing through the filter to the exterior.

6. The bidirectional optical transmitting and receiving device of claim 1, further comprising:
a monitor element provided on the thermoelectric cooler and monitoring light emitted from the light emitting element.

7. The bidirectional optical transmitting and receiving device of claim 1, further comprising:
an isolator provided on the thermoelectric cooler and between the filter and the first lens.

8. The bidirectional optical transmitting and receiving device of claim 1, wherein light reflected by the filter is directly propagated to the light receiving element via the third lens.

9. The bidirectional optical transmitting and receiving device of claim 1, wherein the support surrounds the light receiving element and the pre-amplifier with the bottom case and the filter.

10. The bidirectional optical transmitting and receiving device of claim 9, wherein the support has a light blocking function.

11. The bidirectional optical transmitting and receiving device of claim 1, wherein the support comprises:
a sidewall extending in a direction perpendicular to an upper surface of the bottom case; and
an upper surface coupled with an upper surface of the sidewall and provided over the second portion in parallel with the upper surface of the bottom case,
wherein a hole is provided at the upper surface of the support to expose the light emitting element.

12. The bidirectional optical transmitting and receiving device of claim 11, wherein the filter is provided on the hole.

13. The bidirectional optical transmitting and receiving device of claim 1, further comprising:
a substrate provided on the thermoelectric cooler, the temperature sensor and the light emitting element provided on the substrate.

14. The bidirectional optical transmitting and receiving device of claim 1, wherein the bottom case, the sidewall case, the upper case, and the second lens are sealed by a laser welding process.
